(19) United States
(12) Patent Application Publication
(10) Pub. No.: US 2024/0426634 A1
(43) Pub. Date: Dec. 26, 2024

(54) NEAR-FIELD TRACKING

(71) Applicant: HAAG-STREIT GMBH, Mannheim (DE)

(72) Inventors: Nikolaj NOCK, Mannheim (DE); Daniel BORRMANN, Mannheim (DE)

(21) Appl. No.: 18/699,020

(22) PCT Filed: Oct. 6, 2022
(86) PCT No.: PCT/EP2022/077771

§ 371 Date: Apr. 5, 2024

(30) Foreign Application Priority Data
Oct. 7, 2021 (DE) 102021126056.6

(51) Int. Cl. G01D 5/14

(52) U.S. Cl. CPC G01D 5/14

(57) ABSTRACT

A computer-aided method for determining the actual position of a magnet structure in a space with an analysis module, wherein the analysis module carries out the actual position determination on the basis of measurement data of a magnetic field of the magnet structure, wherein the analysis module uses a data set to determine the actual position, wherein the data set has entries by which basic magnetic field value positions relative to the magnet structure in the space are assigned corresponding basic magnetic field values of the magnetic field of the magnet structure.

### FIELD OF THE INVENTION

The invention relates to a computer-aided method for determining the actual position of a magnet structure in a space by means of an analysis module, wherein the analysis module performs the actual position determination on the basis of measurement data of a magnetic field of a magnet structure. An analysis module can be a unit of a computer program, wherein the analysis module uses a data set to determine the actual position, wherein the data set has entries by means of which basic magnetic field value positions relative to the magnet structure in the room are assigned corresponding basic magnetic field values of the magnetic field of the magnet structure.

### BACKGROUND OF THE INVENTION

A method for determining the actual magnetic position using a permanent magnet is already known from EP 2 256 521 A1, in which the magnetic field of a permanent magnet is measured and the actual position of the permanent magnet is calculated from the measured values.

DE 10 2015 203686 A1 describes a method and an arrangement for determining the position of a magnetic body using magnetic field sensors.

DE 103 07 580 B3 describes a method for determining and tracking the position and orientation of a magnetic field sensor. A calibration table is used here. In the calibration table, each grid point has a position vector p with the coordinates x, y, z in the real magnetic field space, to which a position vector pM with the calibration positions xM, yM and zM and a rotation vector of the calibration orientation pMO with orientation values are assigned.

DE 198 23 059 A1 describes a method and a device for detecting the spatial position of a body on a surface with sensors, whereby the signals of the sensors are detected and an identification of the signals is carried out by an evaluation device, whereby the spatial position of the body is determined from the result of the identification.

US 2016/174872 A1 describes a method for generating a magnetic field in a region of a first magnetic field radiator, which is located at a first position, and a second magnetic field radiator, which is located at a second position.

In corresponding methods, the magnetic field is approximated by magnetic dipoles or higher orders for the calculation. However, this approximation is inaccurate or too complex, particularly in the close range of the magnets, so that the actual position cannot be determined with sufficient accuracy. A more precise calculation is often not possible, partly due to the limited computing power of the computers on which the analysis modules run, as it would require the magnetic field to be calculated in a more complex way.

### SUMMARY OF THE INVENTION

The invention is based on the task of improving the accuracy of determining the actual position, particularly in the near field of the magnet structure, while saving computing power.

The problem is solved in accordance with the invention in that the data set has a data structure, and in that the base magnetic field value position is determined from the position of the respective entry within the data structure, wherein
a) for an asymmetrical magnet structure, the data structure corresponds to a search tree with several pointers which enable navigation through the data structure, or
b) for a magnet structure formed from one or more individual rotationally symmetrical magnets, such as cylindrical magnets or disc magnets, the data structure corresponds to a simple table.

The basic magnetic field values can be read from the entries in the data set for various basic magnetic field value positions. In this respect, the data set has entries that can be used to assign basic magnetic field value positions to the basic magnetic field values of the magnet structure. These basic magnetic field value positions can be basic magnetic field value positions. The data set is created by means of calculation and/or simulation and/or experiment. To determine the base magnetic field values and the associated base magnetic field value positions, the magnet structure can be assumed to be in a base position. The base position can be selected in such a way that the magnet structure lies with its center of gravity in a specific position of a Cartesian coordinate system and has a fixed orientation. This position can be the origin.

This means that the accuracy of the actual position determination can be significantly improved, particularly in the near field of the magnet structure, if the data set contains corresponding entries that are based on a complex calculation of the magnetic field. In this respect, the actual position is not calculated directly, but is determined using the data set. The previously calculated basic magnetic field values are compared with the measurement data. This measurement data corresponds to the measured magnetic field values. This saves computing power.

The analysis module uses the entries in the data set to determine the actual position. The actual position can be the actual position and the actual orientation. In this case, the actual position is the 6D pose, which comprises three position values x, y, z (actual position) and three orientation values Rx, Ry, Rz (actual orientation) with reference to the three room axes, whereby the orientation values indicate the rotation around the respective spatial axis. This also applies accordingly to the basic magnetic field value positions.

The entries correspond to a base magnetic field value, which indicates the strength of the magnetic field at a base magnetic field value position relative to the magnet structure. The base magnetic field value position indicates the position of the base magnetic field value in relation to the magnet structure. The base magnetic field value can correspond to a three-dimensional magnetic field vector.

The actual position is the position of the magnet structure relative to the magnetic field sensors in the room that comes closest to the actual position. The actual position can be determined using a neural network or a minimisation algorithm. The minimisation algorithm varies different positions of the magnet structure around a starting value until the actual position is found. Base magnetic field values for the different positions of the magnet structure in the room are read from the entries in the data set using a transfer function. In order to read out basic magnetic field values for a position of the magnet structure and for positions at which magnetic field sensors are provided from the data set, the transfer function first determines the basic magnetic field value positions of the relevant entries in the data set. The transfer function transforms the basic magnetic field values, which are tabulated in a Cartesian coordinate system in the data set, into a coordinate system of the magnetic field sensors. In this way, a tilt of the two coordinate systems is taken into account.

If only cylindrical magnets or disc magnets with an axis of symmetry MS are involved, which is also the axis of symmetry FS of the magnetic field F, the basic magnetic field value position can only be calculated for a partial plane. The partial plane can be one half of a half plane of the magnetic field, i.e. one quarter of a cross-sectional plane through the axis of symmetry FS. The other values for the magnetic field F or all other planes can be determined on the basis of the symmetry, a calculation is not necessary. A simple table with a number of Cs columns and Cz rows for the entries of the basic magnetic field value position can therefore be used for the data set. The respective cell has the column index iₛ and the row index i_{z}. The position of the respective cell and thus the base magnetic field value position within the table is determined from the column index iₛ or the row index i_{z} of the cell (see comments on FIG. 8a). Separate cells with row or column information are therefore not necessary.

The entries represent the magnetic field around the magnet structure in space. A basic magnetic field value position is assigned to a basic magnetic field value. The base magnetic field value position is the position of the base magnetic field value relative to the magnet structure. With regard to the terms position and location, the above applies to the actual position. The base magnetic field value position can be a base magnetic field value position. When determining a position of the magnet structure, the transfer function accesses specific entries with a specific position within the data set. The data structure corresponds to that of a search tree. The data structure has nodes that are either reference nodes with at least two pointers or data nodes with at least one entry. The pointers each point to another node. The pointers enable navigation through the data structure. The pointers can be used to find a data node that corresponds to a searched base magnetic field value position and the base magnetic field value, which is stored as an entry in the data node, can be retrieved.

It can also be advantageous if, for the calculation
a) the magnet structure has been broken down into its individual magnets,
b) the basic magnetic field value was calculated at least for a partial plane of the magnetic field of the respective individual magnet and
c) the entire magnetic field of the individual magnet is determined on the basis of the calculated part of the magnetic field for the partial plane. This considerably reduces the size of the data set, which allows the use of a table structure. The latter at least when using two to six disc magnets.

It can also be advantageous if a measuring station is provided, whereby the magnetic field is recorded by several sensors of the measuring station. The measurement data is thus recorded and made available for determining the actual position. Each sensor measures a magnetic field value.

At least 2 or at least 5 or at least 26 sensors or exactly 26 sensors are provided. As the number of sensors increases, the stability and accuracy of the measuring station and the determination of the actual position increase.

It can also be advantageous if the basic magnetic field values of the magnet structure or the respective rotationally symmetrical individual magnet have been calculated, whereby at least one segment of the magnet structure has been approximated as a dipole at least once in a dipole approximation during the calculation, whereby the results of this calculation are available in the data set. The results are available as entries in the data set. The calculation can be performed numerically and/or analytically.

The magnet structure can consist of one or more individual magnets. A single magnet of any shape, in particular a disc magnet or a bar magnet, can be considered as a single magnet. A calculation using the dipole approximation saves computing power and provides reliable results.

It can also be advantageous if the basic magnetic field values of only one of these identical individual magnets are calculated when using rotationally symmetrical individual magnets of the same size, regardless of the respective magnetic constant. This significantly reduces the size of the table and its contents.

It can also be advantageous if to create the entries of the data set a) the magnet structure or the respective rotationally symmetrical individual magnet was divided into at least two segments, b) the magnetic field of each segment was calculated using the dipole approximation and c) the calculated magnetic fields were totalled. This is a complex calculation. The decomposition increases the accuracy of the pre-calculated magnetic field measurement values, particularly in the near field of the magnet structure. If the magnet structure has several magnets, the magnet structure is first broken down into the individual magnets that form the magnet structure and then the individual magnets are broken down into segments. A segment is only assigned to one individual magnet. A segment is therefore a part of a single magnet.

The magnet structure, i.e. the individual magnet or the individual magnets that form the magnet structure, was broken down into at least 10 segments per cubic millimetre or at least 20 segments per cubic millimetre or at least 25 segments per cubic millimetre or at least 30 segments per cubic millimetre or at least 40 segments per cubic millimetre. The more segments per cubic millimetre are used, the more accurate the result.

If the basic magnetic field values are calculated solely using the dipole approximation for a D8H3 cylinder magnet, there is a deviation between the real magnetic field and the calculated magnetic field due to the approximation. This deviation is smaller if the D8H3 cylindrical magnets are calculated in a complex manner as described and, in particular, are first broken down into segments. If the D8H3 cylinder magnet has a cylindrical shape with a diameter of 8 mm and a height of 3 mm and the magnet structure is broken down into 1,350 dipoles for the calculation, i.e. approximately 27 dipoles per cubic millimetre, the average relative deviation is 90% in a plane 13 mm in front of the magnet surface between the two calculations. The accuracy of the magnetic field based on the complex calculation is correspondingly more accurate.

It can be advantageous if the distance between the base magnetic field value positions of two spatially closest entries varies. The spatial density of the entries varies accordingly. In this respect, there are more entries in areas where the magnetic field changes significantly, i.e. the space is more finely subdivided. In these areas, the distance between the base magnetic field value positions of two spatially closest entries is smaller. The distances could also be equidistant. However, it is advantageous to sample the magnetic field values more densely for large field changes.

The density of the entries, i.e. the distance between the base magnetic field value positions, is selected in such a way that the difference between the read-out and real magnetic field values is as small as possible with the smallest possible number of base magnetic field values when the data set is subsequently used. This can be achieved by ensuring that the gradient of the field strength in relation to the total strength of the magnetic field values at relevant positions is smaller than a threshold value. This threshold value can be 10% of the magnetic field strength.

The search tree therefore only has a greater depth in the areas in which there are more entries.

It can be of particular importance for the present invention if the actual position is determined at least partially by a neural network. For this purpose, the measurement data, i.e. the measured magnetic field values, are made available to the neural network. A neural network provides the actual position without requiring a great deal of computational effort. In addition, there is no need for an initial value from which the neural network has to start its calculation. The neural network can therefore determine the starting value for a minimisation algorithm.

In connection with the design and arrangement according to the invention, it can be advantageous if the neural network has been trained using the data set. The granularity of the data set may have previously been increased by trilinear interpolation. The error in the specification of the actual position by the neural network essentially corresponds to the error of the data set with which it was trained. As the data set generated using the complex calculation has a very high accuracy, the neural network therefore provides correspondingly more accurate results than if it was trained using a data set in which the individual magnets were approximated as a dipole.

It can also be advantageous if a minimisation algorithm, in particular the Leven-berg-Marquardt algorithm, is used at least in part to determine the actual position.

Minimisation by the minimisation algorithm is performed by minimising the difference between the measurement data, i.e. the measured magnetic field values and the base magnetic field values read from the data set. During minimisation, the position of the magnet structure is varied until the difference is minimised. The position for which the difference is minimised is the actual position. During minimisation, the minimisation algorithm uses the transfer function. The minimisation algorithm can be used to determine the actual position very precisely. It can be more accurate than the determination by the neural network.

It can also be advantageous if a transfer function is used to select entries in the data set that represent or correspond to a desired position of the magnet structure. The transfer function is a function of the position and returns basic magnetic field values. The transfer function first determines the base magnetic field value positions of the relevant entries depending on the position of the magnet structure and the sensor positions and then reads out these entries. The base magnetic field values read out are transformed into the coordinate system of the sensors. The basic magnetic field values can therefore be compared with the measured magnetic field values. The transfer function returns a base magnetic field value for each magnetic field sensor, which is compared with the measured base magnetic field value of the corresponding magnetic field sensor during minimisation.

It can also be advantageous if a start position for the minimisation algorithm is determined using the neural network. The actual position is determined iteratively and continuously within each reconstruction step. The start position for the first reconstruction step is determined using the neural network. From the second reconstruction step on-wards, the start position that is assumed for the next reconstruction step is the end position from the previous reconstruction step. The interaction between the two algorithms means that the actual position is determined very accurately.

It can also be advantageous if the granularity of the data set is summarised by means of trilinear interpolation in the case of a tree structure or by means of bilinear interpolation in the case of a table. The interpolation is performed each time the entries in the data set are accessed to determine the actual position. This also increases the accuracy of the actual position determination.

It can be advantageous if before determining the actual position, the magnet structure is attached to a body whose position in space is to be determined, whereby the position of the body in the space is determined from the actual positions determined. The body can be a gonioscope, a magnifying glass or a lens. If the actual position of the magnet structure is known, the position of the body in space can be precisely determined.

Finally, it may be advantageous if a combination of at least a first pair of magnets is used for the magnet structure. The magnet structure is used in the computer-aided method as described. It can be advantageous if the magnets are designed as disc magnets or bar magnets.

It can also be advantageous if the magnet structure has a second pair of magnets. The other magnets are also designed as disc magnets. The center axes of the magnets of the second pair are parallel.

This results in improved accuracy for the calculation of the actual position. In addition, the additional magnets cancel out the far field of the magnet structure even more efficiently than is the case with a single pair of magnets. This results in less interference from external magnetic sensors. By cancelling out the far field of the magnet structure, the expansion of the magnetic field is limited.

It can also be advantageous for magnets of the two pairs to be tilted relative to the common axis, in particular by 30° or 20° or 10° or 5° or 2°.

It can also be advantageous if the magnet structure has a third pair of magnets, in particular in the form of disc magnets. The magnets of the third pair are arranged outside the plane. The center axes of the third pair of magnets are orthogonal to the center axes of the first pair of magnets and/or the second pair of magnets, in particular with a maximum deviation of 30° or 20° or 10° or 520 or 2°. The third pair of magnets is arranged above the plane E1, in particular in alignment with the magnets of the first and/or second pair. The additional magnets improve the unambiguity of the measurement.

Ultimately, it can be advantageous if the magnets of the first and/or the second and/or the third pair have different magnetic field strengths and/or are the same size. The magnets have at least two or exactly two different magnetic field strengths. Due to the different magnetic field strengths, the magnetic field is asymmetrical. The asymmetry of the magnet structure allows a clear determination of the actual position.

The magnets of the first pair have the same magnetic field strength. The magnets of the second pair have the same magnetic field strength. The magnets of the first pair have a different magnetic field strength than the magnets of the second pair. Two magnets of the first and/or second pair that are directly adjacent in the circumferential direction U of the center axis of the magnet structure have different magnetic field strengths.

The magnets of the third pair have two different magnetic field strengths, whereby the magnetic field strength of one magnet corresponds to the magnetic field strength of the magnets of the first pair and whereby the magnetic field strength of the other magnet corresponds to the magnetic field strength of the magnets of the second pair. A further plane E2 orthogonal to the plane E1 with the first and/or the second pair of magnets can be formed mentally, whereby the plane E2 divides the space into two halves H1, H2, whereby the magnets in each half have the same magnetic field strength.

Due to the different magnetic field strengths, the clarity of the measurement can be improved.

Furthermore, the use of a magnet structure as described in a computerised method as described may be advantageous.

In addition, a magnetic field tracking station comprising an analysis module and/or a measuring station using the computerised method as described and/or having a magnet structure as described may be advantageous.

It may advantageously be provided that the magnetic field tracking station comprises a body, wherein the body is designed as a gonioscope or a magnifying glass.

### BRIEF DESCRIPTION OF THE DRAWINGS

Further advantages and details of the invention are explained in the patent claims and in the description and shown in the figures. It shows:

FIG. 1 the magnetic field tracking station;

FIG. 2 the 6D pose;

FIG. 3 the computerised procedure;

FIG. 4a the data record structure;

FIG. 4b Refinement of a data set range;

FIG. 4c Base magnetic field value position and base magnetic field value;

FIG. 5 the magnet structure with a pair of magnets;

FIG. 6 the magnet structure with two pairs of magnets;

FIG. 7 the magnet structure with three pairs of magnets;

FIG. 8a the data set structure for a disc magnet;

FIG. 8b Magnetic field of a disc magnet.

### DETAILED DESCRIPTION OF THE INVENTION

According to FIG. 1, a magnetic field tracking station 50 has an analysis module 10, a measuring station 20 and a magnetic field structure 100. The measuring station 20 has sensors 21 that detect the magnetic field of the magnetic field structure 100 in a space 200. The measurement data from the sensors 21 are evaluated by the analysis module 10 and an actual position of the magnetic field structure 100 in the space 200 is determined. The magnetic field structure 100 is attached to a body 150, the actual position of which can be determined via the magnetic field structure 100.

The body 150 shown is designed as a magnifying glass. Alternatively, it can also be designed as a lens or as a gonioscope.

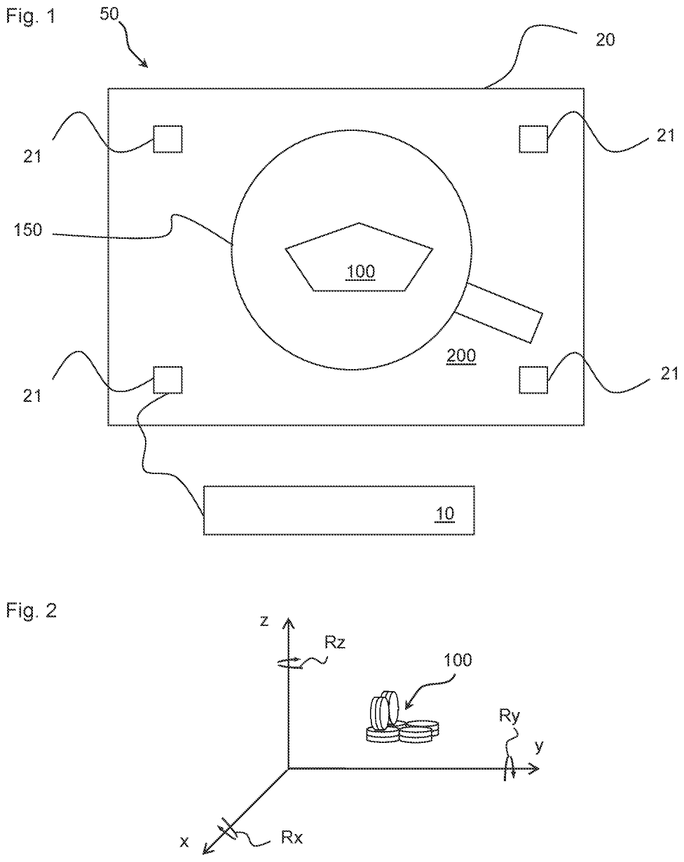

The determined actual position is the position of the magnet structure 100 relative to the magnetic field sensors and, according to FIG. 2, a 6D pose which comprises three position values and three orientation values Rx, Ry, Rz with reference to the three room axes X, Y, Z, whereby the orientation values indicate the rotation about the respective spatial axis.

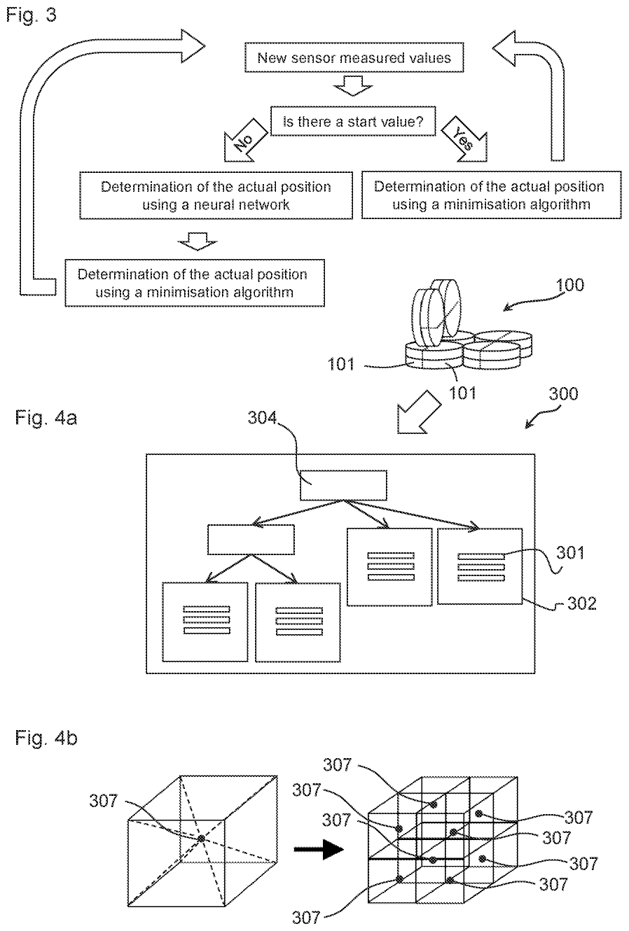

A process for calculating the actual position of the magnet structure 100 is shown in FIG. 3. The calculation is performed continuously and iteratively. Firstly, the sensor measurement data is transmitted to the analysis module 10 so that a new reconstruction step can begin. If no actual position is available yet that can serve as a starting value for the further calculation, the actual position is first determined using a neural network. For this purpose, the measurement data, i.e. the magnetic field values measured by the sensors, are analysed. This actual position is then specified using a minimisation algorithm. The minimisation algorithm is a Levenberg-Marquardt algorithm. The actual position determined in this way is the starting value for the next reconstruction step, so that if a starting value is available, the actual position is determined directly using the minimisation algorithm on the basis of the new measurement data.

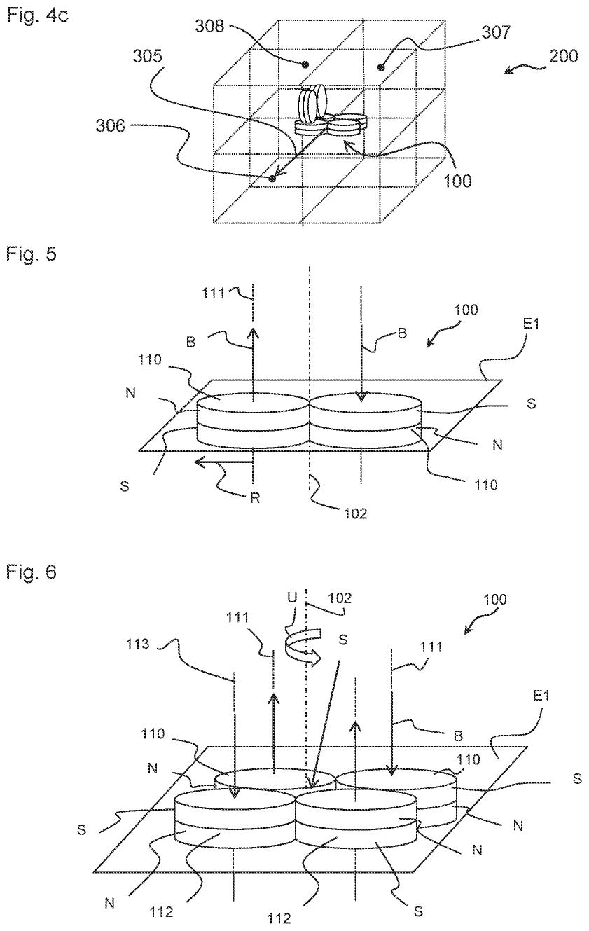

The analysis module 10 uses a data set 300 as shown in FIG. 4a to determine the actual position, whereby the data set 300 has entries 301. The entries 301 represent the magnetic field around the magnet structure 100 in the space 200. For this purpose, basic magnetic field value positions 305 and basic magnetic field values 306 as shown in FIG. 4c are assigned to each other. The base magnetic field value position 305 is relative to the magnet structure 100. The magnet structure 100 is assumed to be in a base position in which its center of gravity lies at the center of a coordinate system and in which the magnet structure 100 has a specific orientation. In this respect, the base magnetic field value position 305 of a base magnetic field value 306 corresponds to a vector from the center of gravity to this base magnetic field value 306. The base magnetic field values 306 are stored in the entries 301 of the data set 300 as three-dimensional magnetic field vectors. The base magnetic field value position 305 results from the position of the entries 301 within the data set 300, as will be explained in detail later.

The change in the magnetic field in space 200 varies in intensity. In the areas of the space 200 in which the magnetic field changes significantly, more basic magnetic field values 306 are generated by further subdividing the space 200 than in areas with smaller changes in the magnetic field. According to FIG. 4c, a possible refinement of a data set area into eight sub-areas is provided, whereby the length of the data set area is halved on each axis. This generates an additional entry 307 of magnetic field values in each of the eight sub-areas. The magnetic field value for a data record area is calculated at a center position in each case, as shown in FIG. 4a, left-hand side.

To determine the actual position of the magnet structure 100, a minimisation algorithm accesses the entries 301 of the data set 300. In this sense, minimisation is initially performed by calculating the differences between the measured magnetic field values and the base magnetic field values 306 stored in the data set. The calculations are based on positions of the magnet structure 100 around the starting value. The actual position of the magnet structure 100 is then the position for which the difference amount is minimal.

To calculate the differential amounts, the corresponding base magnetic field values 306 stored in the data set 300 must be compared with the magnetic field values measured by the sensors 21. This is done by means of a transfer function. In a first step, the transfer function determines the base magnetic field value positions 305 of the relevant entries 301 in the data set 300 as a function of the position of the magnet structure 100. The sensor positions are stored in the transfer function. In a second step, the base magnetic field values 306 of the entries 301 of the data set 300 for which the base magnetic field value positions 305 were determined are read out using the transfer function. The number of base magnetic field values 306 read out corresponds to the number of magnetic field sensors 21. The transfer function then transfers the base magnetic field values 306 read out into the coordinate system of the magnetic sensors 21.

In order to further refine the entries 301 of the data set 300, the granularity of the data set 300 is compressed by means of trilinear interpolation and thus refined when the data set 300 is accessed. This means that not only the base magnetic field values 306 at the base magnetic field value locations 305 that are specifically present in the data set 300 are taken into account in the minimisation, but that base magnetic field values 306 for base magnetic field value locations 305 that lie between the specifically present entries 301 are extrapolated. The neural network was also trained using the data set 300 after its granularity was increased by trilinear interpolation.

According to FIG. 4a, the data set 300 has a data structure of a search tree, which consists of a collection of nodes 302, 304 that form a tree. The nodes are either data nodes 302 or reference nodes 304. The reference nodes 304 contain pointers that point to further nodes 302, 304 and allow the data structure to be searched. The data nodes 302 contain an entry 301 in which the magnetic field is stored by means of a three-dimensional vector, whereby the base magnetic field value position 305 results from the arrangement of the data node 302 within the data structure and can be determined by means of the pointers. The search tree always has a greater depth in the areas in which the magnetic field changes significantly, as the additional entries 307 are stored in the search tree. In this respect, an additional reference node 304 is provided above the two left-hand data nodes 302 in FIG. 4a.

To create the entries in the data set 300, the magnet structure 100 was first broken down into the individual magnets M. These individual magnets M were divided into segments 101. These individual magnets M were divided into segments 101. The magnetic field of each segment 101 was then calculated using the dipole approximation and the magnetic fields of the calculated dipoles, i.e. the results of the dipole approximation, were then totalled.

The magnet structure 100, which is used in the method described, is shown in FIG. 5. The magnet structure 100 has a first pair of magnets 110. The respective magnet 110 is designed as a disc magnet. The magnets 110 of the first pair each have a center axis 111 which runs through a north pole N and a south pole S of the corresponding magnet 110. The center axes 111 are parallel.

The magnets 110 are arranged directly one behind the other in a direction R radial to a center axis 111 and lie in a common plane E1. The magnet structure 100 has a center axis 102 which runs through its center of gravity SP and which is orthogonal to the plane E1 and parallel to the center axes 111 of the magnets 110 of the first pair. The magnets 110 are arranged point-symmetrically to the center of gravity SP.

The magnets 110 of the first pair have a magnetic field direction B coaxial to their center axis 111, wherein the magnetic field direction B runs from the north pole N to the south pole S, wherein the magnetic field direction B of the magnets 110 of the first pair is opposite.

According to FIG. 6, magnets 112 of a further pair of magnets are provided. The respective magnet 112 is designed as a disc magnet. The center axes 113 of the magnets of the second pair 112 are parallel to each other. The center axes 113 of the second pair of magnets 112 are parallel to the center axes 111 of the first pair of magnets 110. The magnets of the second pair 112 lie in the common plane E1. The magnets 110, 112 of the first and second pair form the four corners of a square distributed on the plane E1. The magnets 110, 112 are point-symmetrical to the center of gravity. The magnetic field direction B of two magnets 110, 112 lying next to each other in the circumferential direction U to the center axis 102 of the magnet structure 100 is opposite. The magnetic field strength of the magnets 112 of the second pair is different from the magnetic field strength of the magnets 110 of the first pair. The corresponding magnetic field strength is indicated by the length of the arrows for the magnetic field direction B.

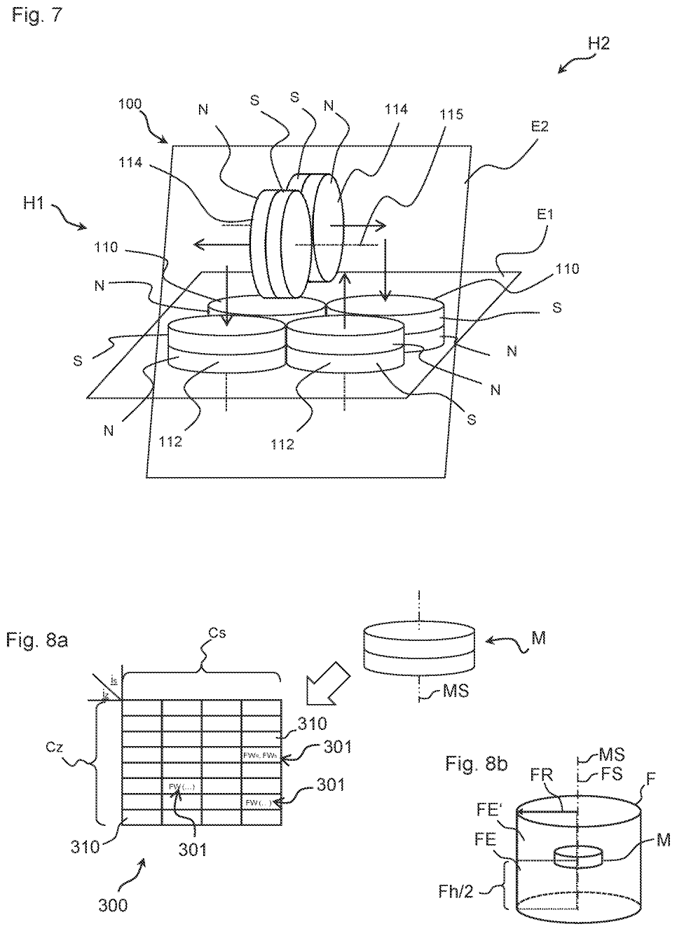

According to FIG. 7, two further magnets 114 with center axes 115 of a third pair are provided. The respective magnet 114 is also designed as a disc magnet. The magnets of the third pair 114 are arranged outside the plane E1. The center axes 115 of the third pair of magnets 114 are each orthogonal to the center axes 111, 113 of the first pair of magnets 110 and the second pair of magnets 112.

The third pair of magnets 114 is arranged above the plane E1 above, or in alignment with the magnets of the first and/or the second pair 110, 112. The magnets 114 of the third pair have two different magnetic field strengths, wherein the magnetic field strength of one magnet 114 corresponds to the magnetic field strength of the magnets 110 of the first pair and wherein the magnetic field strength of the other magnet 114 corresponds to the magnetic field strength of the magnets 112 of the second pair. As a result, the magnetic field of the magnet structure 100 is asymmetrical.

An imaginary plane E2 orthogonal to the plane E1 divides the space into a first half H1 and a second half H2, with the magnets 110 of the first pair lying in the second half H2 and the magnets 112 of the second pair lying in the first half H1. In addition, the magnet 114 of the third pair with the same magnetic field strength as the pair of magnets 110 is located in the same half H2. The same applies to the other magnet 114 in relation to the pair of magnets 112 and the half H1.

According to the example in FIG. 8a, the magnet structure 100 was first broken down into the individual magnets M to create the entries in the data set 300. These are exclusively cylindrical magnets or disc magnets with an axis of symmetry MS. The magnetic field F of the disc magnet M has the same axis of symmetry FS. The magnetic field F has the height Fh and the radius FR. According to FIG. 8b, the basic magnetic field value position 305 is only calculated for a partial plane FE, i.e. a quarter of the cross-sectional plane of the magnetic field F, i.e. over half the height Fh/2 and over the radius FR. The other values for the magnetic field F and all other planes are determined on the basis of the symmetry, a calculation is not necessary. The calculated basic magnetic field value position is independent of a swivelling angle around the symmetry axis FS. The base magnetic field value position 305 calculated for the lower half FE of the half plane shown is mirror-symmetrical to the base magnetic field value position of the upper half FE′.

The data set structure is a simple table with a number of Cs columns and Cz rows for the entries 301 of the base magnetic field value position 305. The respective cell 310 has the column index is and the row index i_{z}. The position of the respective cell 310 and thus the base magnetic field value position within the table is determined from the column index is or the row index i_{z} of cell 310.

The magnetic field values can be precalculated and stored along the direction R or the radius FR and along the symmetry axis FS, i.e. over the height Fh at discrete points with equidistant spacing. This produces a 2-dimensional table whose column and row indices can be used to reconstruct the position P (PR, Ph), i.e. the corresponding magnetic field value position results from the indices and does not have to be stored in the table.

Each entry is a 2-dimensional magnetic field value in polar coordinates, as shown in the example of the column index of the respective cell iₛ:

$${i}_{s} = {}^{′} {round}^{′} ( Pr / FR ( Cs - 1 ) ) ,$$

where Pr=radius of the corresponding magnetic field position, FR=radius of the magnetic field and Cs=number of columns in the table, each rounded to an integer.

The associated column index iₛ of the table can therefore be calculated for a specified radius PR. The row index is calculated in the same way.

However, as the magnetic field strength decreases with the distance to the third power and to further increase accuracy, the distance between the data values can also be varied. For example, the data values in areas with potentially higher magnetic field value changes can be stored at smaller distances than in areas with potentially lower magnetic field value changes. One way of subdividing the subplane is not to discretise the magnetic field values at equidistant distances, but to calculate the positions according to a power function of the radius or height. For a table with Cs columns and Cz rows, the sample positions can be determined as follows:

$$PR = {FR ( {i}_{s} / ( Cs - 1 ) )}^{e} or Ph = Fh / 2 {( {i}_{z} / ( Cz - 1 ) )}^{e}$$

where PR=radius of the corresponding magnetic field position, Ph=height of the corresponding magnetic field position, Cs=number of columns in the table, Cz=number of rows in the table, iₛ=column index of the respective cell, i_{z}=row index of the respective cell.

The exponent e determines how much the density of the data points is increased as the origin of the magnet M is approached. A value of 1 corresponds to equidistant sampling, higher values to a more pronounced compression. One possible parameter selection is e=3.

When using the table to determine the magnetic field values, the indices for a given position must be determined in reverse. This is done using the above-mentioned inverse formula:

$${i}_{s} = {}^{′} {round}^{′} ( {( Pr / FR )}^{( 1 / e )} ( Cs - 1 ) ) ,$$

To determine the 3-dimensional magnetic field value for the 3-dimensional position P, proceed as follows:
The position P is converted into polar coordinates with radius PR, height Ph and angle PW.
The 2-dimensional magnetic field value FW (FW_{R}, FWₕ) is read from the data structure at the point (PR, Ph). At this point, a bilinear interpolation of the values can be carried out to increase the accuracy.
The 2-dimensional magnetic value obtained is now transformed into the correct spatial half of the magnetic field: FW′_{R},=FW_{R} sign(Ph), FW′ₕ=FWₕ
   taking into account the sign ‘sign’ corresponding to the lower or upper partial plane FE, FE′.
The radial component FW′_{R} is transformed back into Cartesian coordinates FWₓ and FW_{y} using the angle PW.
The three-dimensional value is made up of these two values FWₓ and FW_{y} as well as the value FWₕ from the data structure.

To determine the magnetic field for the entire magnet structure, the magnetic value of the desired position in the local coordinate system of the disc magnet is determined individually for each disc magnet. These values are then rotated in the coordinate system of the magnet pattern and totalled to a common value.

### LIST OF REFERENCE SYMBOLS

10 Analysis module

20 Measuring station

21 Sensor

50 Magnetic field tracking station

100 Magnetic field structure, Magnet structure

101 Segment

102 Center axis

110 Magnets of the first pair

111 Center axis

112 Magnets of the second pair

113 Center axis

114 Magnets of the third pair

115 Center axes

150 Body

200 Space

300 Data set

301 Entries

302 Data node

304 Reference node

305 Basic magnetic field value position

306 Basic magnetic field value

307 additional entry

308 closest entry

310 Cell

B Magnetic field direction

Cs Number of columns in the table

Cz Number of rows in the table

E1 plane

E2 plane

F Magnetic field of the single magnet

FE partial plane of the magnetic field of the single magnet (lower)

FE′ partial plane of the magnetic field of the single magnet (upper)

Fh Height of the magnetic field of the single magnet

FR Radius of the magnetic field

FS Symmetry axis of F

FW value of the magnetic field

H1 first half

H2 second half

ME single magnet, cylinder magnet, disc magnet

MS Symmetry axis of M

N North Pole

P Position

Ph Height of the position

PR Radius of the position

PW Angle of the position

R Direction

S South Pole

SP Center of gravity

U Circumferential direction

x Position

y Position

z Position

Rx Orientation value

Ry Orientation value

Rz Orientation value

What is claimed is:

1. A computer-aided method for determining the actual position of a magnet structure in a space by an analysis module,
wherein the actual position is a 6D pose which, with reference to the three room axes three position values x, y, z (actual position), and three orientation values Rx, Ry, Rz (actual orientation),
wherein the analysis module carries out the actual position determination on the basis of measurement data of a magnetic field (F) of the magnet structure, wherein the analysis module uses a data set for the actual position determination, wherein the data set has entries, by which base magnetic field value positions relative to the magnet structure in the space are assigned corresponding base magnetic field values of the magnetic field of the magnet structure,
wherein the data set has a data structure and the base magnetic field value position is determined from the position of the respective entry within the data structure, wherein
a) for an asymmetrical magnet structure, the data structure corresponds to a search tree with several pointers which enable navigation through the data structure, wherein the data structure consists of a collection of nodes that form a tree, whereby the nodes are either data nodes or reference nodes, whereby the reference nodes contain pointers that point to further nodes and allow the data structure to be searched, whereby the data nodes contain an entry in which the magnetic field is stored by means of a three-dimensional vector, whereby the base magnetic field value position results from the arrangement of the data node within the data structure and can be determined by means of the pointers, or
b) for a symmetrical or for an asymmetrical magnet structure formed from a plurality of rotationally symmetrical magnets (M) the data structure corresponds to a simple table.

2. The computer-aided method according to claim 1, wherein for the calculation
a) the magnet structure was divided into the individual magnets (M),
b) the basic magnetic field value position was calculated at least for a partial plane (FE) of the magnetic field (F) of the respective individual magnet (M), and
c) the magnetic field (F) of the individual magnet is determined on the basis of the calculated magnetic field for the partial plane (FE).

3. The computer-aided method according to claim 1, wherein a measuring station is provided, the magnetic field being detected by means of a plurality of sensors of the measuring station for the purpose of generating the measurement data.

4. The computer-aided method according to claim 1, wherein the basic magnetic field values of the magnet structure or of the respective rotationally symmetrical individual magnet (M) have been calculated, at least one segment of the magnet structure or of the individual magnet (M) having been approximated at least once by means of dipole approximation for the purpose of this calculation.

5. The computer-aided method according to claim 4, wherein, when using rotationally symmetrical individual magnets (M) of the same size, the basic magnetic field values of only one of these identical individual magnets (M) were calculated independently of the respective magnetic constant.

6. The computer-aided method according to claim 3, wherein for the calculation
a) the magnet structure or the respective rotationally symmetrical individual magnet (M) has been divided into at least two segments,
b) the magnetic field of each segment was calculated by means of the dipole approximation and
c) the calculated magnetic fields of all segments were totalled.

7. The computer-aided method according to claim 1, wherein the distance between the base magnetic field value positions of two spatially closest entries varies.

8. The computer-aided method according to claim 1, wherein that the determination of the actual position is carried out at least partially by a neural network.

9. The computer-aided method according to claim 7, wherein the neural network has been trained using the data set.

10. The computer-aided method according to claim 1, wherein that a minimisation algorithm, in particular the Levenberg-Marquardt algorithm, is used at least in part in the determination of the actual position.

11. The computer-aided method according to claim 1, wherein a transfer function is used to select entries of the data set which represent or correspond to a desired position of the magnet structure.

12. The computer-aided method according to claim 7, wherein a start position for the minimisation algorithm is determined by the neural network.

13. The computer-aided method according to claim 1, wherein the granularity of the data set is compressed by means of trilinear interpolation or bilinear interpolation.

14. A computerised method according to claim 1, wherein in that, prior to determining the actual position, the magnet structure is attached to a body whose position in the space is to be determined, the position of the body in the space being determined from the determined actual positions.

15. A magnet structure for use in a method according to claim 1, wherein a combination of at least a first pair of magnets is used for the magnet structure.

16. The magnet structure according to claim 15, wherein, the magnet structure comprises a second pair of magnets.

17. The magnet structure according to claim 16, wherein, the magnet structure comprises a third pair of magnets.

18. The magnet structure according to claim 17, wherein, the magnets of the first and/or the second and/or the third pair have different magnetic field strengths and/or have the same size.

19. A use of a magnet structure according to claim 15 in a computerised method for determining the actual position of a magnet structure in a space by an analysis module,
wherein the actual position is a 6D pose which, with reference to the three room axes three position values x, y, z (actual position), and three orientation values Rx, Ry, Rz (actual orientation),
wherein the analysis module carries out the actual position determination on the basis of measurement data of a magnetic field (F) of the magnet structure, wherein the analysis module uses a data set for the actual position determination, wherein the data set has entries, by which base magnetic field value positions relative to the magnet structure in the space are assigned corresponding base magnetic field values of the magnetic field of the magnet structure,
wherein the data set has a data structure and the base magnetic field value position is determined from the position of the respective entry within the data structure, wherein
a) for an asymmetrical magnet structure, the data structure corresponds to a search tree with several pointers which enable navigation through the data structure, wherein the data structure consists of a collection of nodes that form a tree, whereby the nodes are either data nodes or reference nodes, whereby the reference nodes contain pointers that point to further nodes and allow the data structure to be searched, whereby the data nodes contain an entry in which the magnetic field is stored by means of a three-dimensional vector, whereby the base magnetic field value position results from the arrangement of the data node within the data structure and can be determined by means of the pointers, or
b) for a symmetrical or for an asymmetrical magnet structure formed from a plurality of rotationally symmetrical magnets (M) the data structure corresponds to a simple table.

20. A magnetic field tracking station comprising an analysing module and/or a measuring station, wherein the computer-assisted method according to claim 1 is used and/or which comprises a magnet structure wherein a combination of at least a first pair of magnets is used for the magnet structure.

21. The use of a magnetic field tracking station according to claim 20, wherein the magnetic field tracking station comprises a body, wherein the body is formed as a gonioscope or a magnifying glass.
